(19) United States
(12) Patent Application Publication
(10) Pub. No.: US 2007/0095336 A1
(43) Pub. Date: May 3, 2007

(54) Collapsible picnic grill

(75) Inventor: Matthias Pfuller, Heimbach-Vlatten (DE)

Correspondence Address: RICHARD M. GOLDBERG, 25 EAST SALEM STREET, SUITE 419, HACKENSACK, NJ, 07601, US

(73) Assignee: nuardis GmbH, DETMOLD (DE)

(21) Appl. No.: 10/564,252

(22) PCT Filed: Jul. 15, 2004
(86) PCT No.: PCT/EP04/07892

§ 371 Date: Jan. 10, 2006

(30) Foreign Application Priority Data
Jul. 16, 2003 (DE) 103 32 134.9

(51) Int. Cl. A47J 37/07

(52) U.S. Cl. 126/9 R

(57) ABSTRACT

A take-apart picnic grill includes two hollow profiles to be disposed parallel to each other, which are connected by a plurality of rods to form a grilling surface. The hollow profiles are tubes, the diameter of one of which is sufficiently larger than the other to allow the tube with the smaller diameter to be inserted inside the tube with the larger diameter for transport purposes.

The invention concerns a take-apart picnic grill with two hollow profiles to be disposed parallel to each other, which are connected by a plurality of rods to form a grilling surface.

A picnic grill of this type is disclosed in U.S. Pat. No. 6,546,851 B1. This prior art picnic grill comprises two parallel square hollow profiles which are connected at both ends and at a distance to each other by screwable rods, and between which run a plurality of rods which form the grilling surface. At the four ends of the two parallel hollow profiles there are vertical holes into which the legs can be inserted. The disadvantage of this prior art grill is that it consists of a large number of individual parts with no provision made for storing the latter so that individual items do not get lost after taking the grill apart.

This invention is based on the task of creating a grill of the above type which ensures that once the grill is taken apart, it can be safely stored with no risk of losing individual parts.

To solve this task the picnic grill according to the invention is characterised in that the hollow profiles are tubes, the diameter of one of which is sufficiently larger than the other to allow the tube with the smaller diameter to be inserted inside the tube with the larger diameter for transport purposes.

Hence when the grill is not in use it can be taken apart and the smaller tube can be inserted inside the larger one. The inside of the smaller tube can then serve to accommodate all the remaining parts.

The inner diameter of the smaller tube is preferably sized so that all the connecting and supporting rods of the grill can be accommodated in its interior. Thus the tube with the larger diameter serves at the same time as a container for accommodating all the other parts of the grill.

The risk of losing individual parts is overcome by providing caps or plugs to close off the ends of the tube with the larger diameter.

To assemble the rods which form the grilling surface and connect the two tubes, one of the tubes is preferably provided with holes along the entire length of this tube whilst in the other tube there are slots in the same number and position, preferably extending through 90° from the top vertex line of the tube through to the lateral vertex line on the side of the tube facing the other tube. In this way the rods can be inserted from above and secured within the slotted tube after the two tubes are pulled together.

In another embodiment, the slotted tube is provided with a longitudinal slot on the side facing the other tube, and the slots in which the rods are inserted, are contrived in the bottom edge of this longitudinal slot. In this case, too, the tubes can be pulled together to prevent the rods from coming loose upwardly.

A notch is preferably provided at the end of at least one of the tubes for the purpose of cleaning the rods after grilling.

At the ends of the two tubes there are screwable rods which hold the two tubes together. Legs which may be vertically adjustable may also be provided at the ends of the two tubes.

Preferred embodiments of the invention will be described in more detail below with reference to the enclosed drawings.

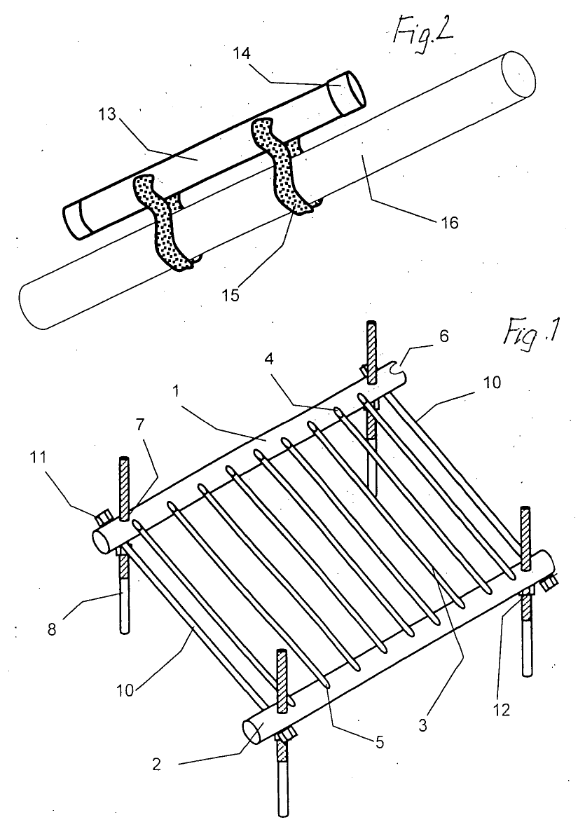

FIG. 1 is a perspective view of a grill according to the invention in the assembled state;

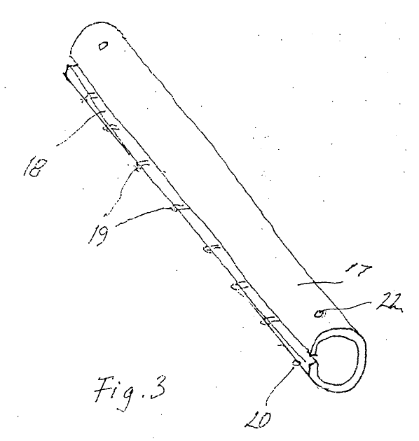

FIG. 2 shows how the packed-up grill is clipped to a bicycle frame;

FIG. 3 is a perspective view of an alternative embodiment of one of the two tubes.

FIG. 1 shows both tubes, designated as 1 and 2. One of the tubes has a slightly larger diameter than the other so that this other tube can be inserted inside the first tube. Thus the drawing is not to scale. The two tubes are disposed parallel to each other and at a distance from each other and a plurality of rods 3 are mounted between tubes 1,2. To the side of tube 1, the rods are inserted in holes 4 which are distributed along the length of the tube. Holes 4 have a slightly larger diameter than the rods so that the latter can be inserted easily. On the opposite side, slots 5 are provided in tube 2, distributed along the length of tube 2 to coincide with the distribution of holes 4 in the other tube 1. The slots preferably run through an angle of about 90° from the top vertex line of the tube through to the side vertex line facing the other tube. When the two tubes 1,2 are pushed towards each other after inserting rods 3, the rods pass through the slots and far enough into the tube to ensure that they cannot be lifted out of position on this side either.

Instead of holes, tube 1 may have slots too, as shown in tube 2. This facilitates the task of assembling the grill even further. In this case, too, the slots should leave a portion of the top tube wall intact as with slots 5 so that rods 3 can be prevented from coming loose upwardly by pulling tubes 1,2 together.

To connect the two tubes 1,2 there are connecting rods 10 which run through holes (not shown) in the two opposite tube walls at the ends of the tubes and are provided at their ends with, for example, a thread onto which wing nuts 11 can be screwed. By tightening these wing nuts the tubes can be pulled together until they are maintained at a distance by the rods abutting against each opposite tube wall. This forms a stable grilling surface.

Also provided in the end portions of tubes 1,2 there are holes 7 running vertically through both tube walls, which, in at least one of the tube walls, can be provided with an inner thread, and into which supports 8 can be screwed. It is also possible to twist nuts 12 onto supports 8, which are accommodated underneath tubes 1,2 and can be twisted along the thread to adjust the height of the grilling surface.

It is expedient to make the two tubes equally long. The length of the tubes should preferably be somewhere between 20 and 30 cm.

At the end of tube 1, a notch 6 is contrived in the tube wall for the purpose of wiping off any remainders of charcoal or grilled food left sticking to rods 3 after grilling.

Tubes 1,2, rods 3, connecting rods 10 and supports 8 are preferably made from metal, in particular steel, above all stainless steel.

The diameter of the rods 3 which form the grilling surface is preferably somewhere between 2 and 6 mm, and 3 mm in particular. These thicknesses are sufficient to produce a stable grilling surface whilst also facilitating the space-saving stowing away of the individual parts of the grill. This is why rods 3 are also slightly shorter than tubes 1,2. The number of rods 3 should be selected so that when the grill is assembled, the gap between the metal rods is not less than 5 mm and not more than 30 mm. A gap of 20 mm is preferred.

Concerning connecting rods 10, wing nuts 11 can be replaced at one end by a headpiece or a plate which prevents the connecting rods from being pulled through the corresponding hole in the tube. A wing nut need then be screwed on from one side only.

It is also possible, however, to provide the ends of connecting rods 10 with threads and to cut a thread into the corresponding holes in tubes 1,2, at least on one side.

In this way the grill can also be tensioned by screwing the connecting rods into the holes.

The diameters of the two tubes 1,2 are contrived so that one of the tubes can be inserted inside the other, and so that the inner tube is able to accommodate the rods 3 that form the grilling surface, the connecting rods 10, the supports 8 and any nuts that are used. All the individual parts of the grill are therefore housed inside the tube with the larger diameter, designated as 13 in FIG. 2. Both ends of this tube can be topped with caps 14 to prevent the parts inside from falling out. One end can, however, also be sealed off with a seal as shown on the left of FIG. 2. One detachable cap 14 suffices for the purpose of inserting the second tube and the other parts of the grill.

FIG. 2 shows an example of how the packed-up grill can be attached to a bicycle frame 16. Two brackets 15, as used to attach pumps to bicycles can be used to clip the grill to the bicycle frame.

When assembling the grill, the two tubes 1,2 are connected first by connecting rods 10, but are not yet pulled together. The rods 3 which form the grilling surface are then first inserted into holes 4 and then placed in the opposite slots 5. Connecting rods 10 are then tensioned with the help of wing nuts 11 or other tensioning devices so that tubes 1,2 are pulled together until rods 3 abut against the opposite inner walls of the tubes. Finally, supports 8 are screwed or pushed into position and vertically adjusted.

After grilling, the rods 3 serving as the grilling surface can be wiped clean of any remaining bits of grilled food using notch 6 at one end of tube 1.

The advantages of the grill according to the invention lie in its compact transport size and in the relatively quick and easy assembly and disassembly procedure. It is also lightweight. The grill can easily be transported on a bike, motorbike, in a car or on a boat, for example.

FIG. 3 shows a tube which corresponds to tube 2 of FIG. 1 and is also provided with slots in which the grill rods can be placed. The tube designated as 17 in FIG. 3 has a longitudinal slit 18 running along a lateral contour line across its entire length or part of its length, in one edge of which—the bottom edge in FIG. 3—crosswise slots 19 are contrived. These slots fulfil the same function as slots 5 in FIG. 1. This tube also has horizontal holes 20 running through both opposite tube walls to accommodate connecting rods 10, and a vertical hole 22 running through both tube walls to accommodate supports 8.

In the drawings, the two tubes 1,2 are shown as circular cylindrical tubes. This embodiment is indeed particularly advantageous. Other cross-section profiles can also be used, however—a quadratic cross section, for example, as disclosed in the document mentioned in the introduction, or an elliptical cross section.

The described arrangement of a longitudinal slit 18 and slots 19 oriented crosswise to one edge thereof can also be used for both tubes. This facilitates the process of assembling the grill even further.

What is claimed is:

1. Take-apart picnic grill comprising:
two hollow profiles adapted to be disposed parallel to each other,
a plurality of rods to connect the two hollow profiles so as to form a grilling surface, and
the hollow profiles including first and second tubes respectively, each with a diameter, the diameter of the first tube being sufficiently larger than the diameter of the second tube to allow the second tube with the smaller diameter to be inserted inside the first tube with the larger diameter for transport purposes.

2. The picnic grill of claim 1, wherein the second tube with the smaller diameter has an inner diameter which is sized in such a way as to accommodate all other parts of the grill.

3. The picnic grill of claim 1, wherein:
one of the tubes has holes in a side facing the other tube to accommodate one end of the rods serving as the grilling surface, and
a top quarter of a circumference of the other tube facing the one tube has slots to match the number of holes for accommodating opposite ends of the rods.

4. The picnic grill of claim 1, wherein:
one of tubes has holes in a side facing the other tube to accommodate one end of the rods which form the grilling surface, and
the other tube includes:
an unbroken longitudinal slit on a side facing the one tube, and
slots in one edge of the slit in which to place opposite ends of rods.

5. The picnic grill of claim 1, wherein a top quarter of a circumference of both tubes is provided with slots on a side facing the other tube.

6. The picnic grill of claim 1, wherein both tubes include an unbroken longitudinal slit in a side facing the other tube, and slots in one edge of the slit in which to place the rods.

7. The picnic grill of claim 1, further comprising a notch at an end of one of the tubes for cleaning the rods which form the grilling surface.

8. The picnic grill of one claim 1, further comprising caps for sealing both ends of the first tube with the larger diameter.

9. The picnic grill of one of claim 1, wherein the first tube with the larger diameter is sealed at one end and further comprising a cap for closing off the other end of the first tube.

10. The picnic grill of claim 1, wherein all parts of the picnic grill are made from stainless steel.

11. The picnic grill of claim 1, wherein the tubes each have a circle cylindrical cross section.
